(19) United States
(12) Patent Application Publication
(10) Pub. No.: US 2017/0326905 A1
(43) Pub. Date: Nov. 16, 2017

(54) PENCIL SHARPENER

(71) Applicant: Sung Bum PARK, Seoul (KR)

(72) Inventor: Sung Bum PARK, Seoul (KR)

(21) Appl. No.: 15/531,366

(22) PCT Filed: Nov. 27, 2015
(86) PCT No.: PCT/KR2015/012849

§ 371 Date: May 26, 2017

(30) Foreign Application Priority Data
Nov. 29, 2014 (KR) 10-2014-0169278

(51) Int. Cl. B43L 23/08

(52) U.S. Cl. CPC B43L 23/085

(57) ABSTRACT

A pencil sharpener is disclosed. The pencil sharpener comprises: a housing part which has an accommodation space thereinside with an open portion formed on one side thereof, and in which a first coupling member is formed on an inner side surface thereof; and a pencil sharpening part which is inserted into the accommodation space of the housing part, has a second coupling member corresponding to the first coupling member formed on an outer side surface thereof, and has a knife blade part thereinside, wherein a pencil, which is inserted into the pencil sharpening part, is sharpened by the knife blade part as at least one area of the pencil sharpening part is rotated by the first coupling member and the second coupling member as a pencil, which is inserted into the pencil sharpening part, makes a straight-line motion in the lengthwise direction of the housing part.

### FIELD OF THE INVENTION

The present invention relates to a pencil sharpener and, more particularly, to a pencil sharpener, in which the linear motion of a pencil made by holding and pressing the pencil is converted into the rotational motion of a pencil sharpening part such that the pencil can be more easily sharpened.

### BACKGROUND OF THE INVENTION

In general, there are four ways to sharpen a pencil, wherein a knife, a portable (prism) pencil sharpener, a manual rotary (planetary) pencil sharpener or an electric pencil sharpener is used. These conventional pencil sharpeners have been developed into a direction in which a user can safely, easily and quickly sharpen a pencil.

However, these conventional pencil sharpeners require two kinds of force, that is, force in a linear direction against the repulsion by a blade and a rotation moment about an axis, which is applied to the pencil in order to sharpen a pencil, and thus some products implement the force in the linear direction with a spring and replace the rotation moment with a motor. However, there has been an inconvenience that the force of the two directions must be applied separately.

### SUMMARY OF THE INVENTION

### Technical Problem

Accordingly, the present invention has been made in an effort to solve the above-mentioned problems and disadvantages, and it is an objective of the present invention to provide a pencil sharpener, in which the linear motion of a pencil made by holding and pressing the pencil is converted into the rotational motion of a pencil sharpening part such that the pencil can be more easily sharpened.

### Technical Solution

In order to achieve the above objective, a pencil sharpener, according to one embodiment of the present invention, includes a housing part having an opening portion formed at one surface portion, an accommodation space formed therein, and a first coupling member formed on an inner surface, and a pencil sharpening part inserted into the accommodation space of the housing part, and having a second coupling member formed on an outer surface thereof and corresponding to the first coupling member, and a knife blade part provided therein, wherein at least one area of the pencil sharpening part is rotated by the first coupling member and the second coupling member as a pencil, which is inserted into the pencil sharpening part, carries out linear motion in the lengthwise direction of the housing part, so that the pencil is sharpened by the knife blade part.

Preferably, the first coupling member is formed as at least one protrusion part and the second coupling member is formed as a screw groove, or the first coupling member is formed as a screw groove and the second coupling member is formed as at least one protrusion part.

In addition, it is preferable that the at least one protrusion part includes a protrusion formed to be protruded from a surface or includes an inner groove and a ball inserted on the inner groove.

Besides, it is preferable that the pencil sharpening part further includes a rotation part, which has the second coupling part formed on the outer surface thereof so as to rotate as the pencil, which is inserted into the pencil sharpening part, carries out linear motion in the lengthwise direction of the housing part, wherein the knife blade part may be coupled to the inside of the rotation part and include at least one fixed blade.

Furthermore, it is preferable that the pencil sharpening part includes an upper rotation part, which has the second coupling part formed on the outer surface thereof so as to rotate as the pencil, which is inserted into the pencil sharpening part, carries out linear motion in the lengthwise direction of the housing part, and a lower fixed part coupled to the lower side of the upper rotation part, wherein the knife blade part may be coupled to the inside of the upper rotation part and include at least one fixed blade.

Moreover, it is preferable that the pencil sharpening part includes an upper rotation part, which has the second coupling part formed on the outer surface thereof so as to rotate as the pencil, which is inserted into the pencil sharpening part, carries out linear motion in the lengthwise direction of the housing part, and a lower fixed part coupled to the lower side of the upper rotation part, wherein the knife blade part may be coupled to the inside of the upper rotation part and include at least one spiral blade for rotating by the interaction between a central shaft, which is formed to be extended from the lower fixed part, and a blade shaft.

In addition, it is preferable that the housing part further includes a third coupling member formed in a linear shape on the inner surface thereof and the lower fixed part may include a fourth coupling member formed on the outer surface thereof and corresponding to the third coupling member.

Besides, it is preferable that the pencil sharpening part includes a lower rotation part, which has the second coupling part formed on the outer surface thereof so as to rotate as the pencil, which is inserted into the pencil sharpening part, carries out linear motion in the lengthwise direction of the housing part, and an upper fixed part coupled to the upper side of the lower rotation part, wherein the knife blade part may be coupled to the inside of the upper fixed part and include at least one spiral blade for rotating by the interaction between a central shaft, which is formed to be extended from the lower rotation part, and a blade shaft.

Furthermore, it is preferable that the housing part further includes a third coupling member formed in a linear shape on the inner surface thereof, and the upper fixed part may include a fourth coupling member formed on the outer surface thereof and corresponding to the third coupling member.

Moreover, it is preferable that the pencil sharpener may further include a spring part arranged at the lower end of the pencil sharpening part and providing upward restoring force in proportion to the lowering of the pencil sharpening part by the pencil, which is inserted into the pencil sharpening part.

In addition, it is preferable that the pencil sharpener may further include a lid part coupled to the upper end of the pencil sharpening part, arranged on the opening portion and having a pencil insertion hole, into which the pencil is inserted.

Besides, it is preferable that the pencil sharpener further includes a lid part coupled to the opening portion of the housing part, wherein the lid part may include a pencil insertion hole, into which the pencil is inserted, and at least one roller part arranged around the pencil insertion hole and coming into contact with the surface of the pencil, which is inserted into the pencil insertion hole, so as to prevent the shaking of the pencil during the insertion motion of the pencil.

Furthermore, it is preferable that the pencil sharpener may further include a tension part arranged between the pencil sharpening part and the lid part and providing upward restoring force in proportion to the lowering of the pencil sharpening part by the pencil, which is inserted into the pencil sharpening part.

Moreover, it is preferable that the pencil sharpening part includes a rotation part, which has the second coupling part formed on the outer surface thereof so as to rotate as the pencil, which is inserted into the pencil sharpening part, carries out linear motion in the lengthwise direction of the housing part, and a ratchet part coupled between the rotation part and the knife blade part and rotating the knife blade part in a first direction when the rotation part rotates in the first direction, while preventing the knife blade part from rotating in a second direction when the rotation part rotates in the second direction, wherein the knife blade part may be coupled to the ratchet part and have at least one fixed blade, which is fixed and coupled on the inside thereof.

In addition, it is preferable that the pencil sharpening part further includes a lower rotation part, which has the second coupling part formed on the outer surface thereof so as to rotate as the pencil, which is inserted into the pencil sharpening part, carries out linear motion in the lengthwise direction of the housing part, wherein the knife blade part includes at least one fixed blade, which is fixed and coupled to the upper side of the lower rotation part, is opened at a side surface portion and can be protruded to the outside of the housing part.

In order to achieve the above objective, a pencil sharpener, according to another embodiment of the present invention, includes a housing part having an upper end opening portion formed at one surface portion, a lower end opening portion formed at the opposite side of the upper end opening portion, and an accommodation space formed therein, and a pencil sharpening part inserted into the accommodation space of the housing part and having a knife blade part provided therein, wherein a first coupling member is formed on the inner surface of the lower end opening portion, wherein the pencil sharpening part further includes a rotation shaft part coupled at the lower end of the knife blade part and having a second coupling member formed on an outer surface thereof and corresponding to the first coupling member, wherein the rotation shaft part is rotated by the first coupling member and the second coupling member as a pencil, which is inserted into the pencil sharpening part, carries out linear motion in the lengthwise direction of the housing part, so that the pencil is sharpened by the knife blade part.

Preferably, the first coupling member is formed as at least one protrusion part and the second coupling member is formed as a screw groove, wherein the knife blade part may include at least one fixed blade, which is fixed and coupled to the upper portion of the rotation shaft part.

In addition, it is preferable that the pencil sharpening part further includes an upper fixed part coupled to the upper side of the rotation shaft part, wherein the knife blade part is coupled to the inside of the upper fixed part and may include at least one spiral blade for rotating by the interaction between a central shaft, which is formed to be extended from the rotation shaft part, and a blade shaft.

In order to achieve the above objective, a pencil sharpener, according to a further embodiment of the present invention, includes a housing part having an opening portion formed at one surface portion such that a pencil is inserted thereinto, an accommodation space formed therein, and a rotation shaft insertion space formed in one area of the accommodation space, and a pencil sharpening part inserted into the accommodation space of the housing part and having a knife blade part provided therein, wherein a first coupling member is formed on the inner surface of the rotation shaft insertion space, wherein the pencil sharpening part further includes a rotation shaft part coupled to one side surface of the knife blade part and having a second coupling member formed on an outer surface thereof and corresponding to the first coupling member, and wherein the rotation shaft part is rotated by the first coupling member and the second coupling member as a pencil, which is inserted into the pencil sharpening part, carries out linear motion in the lengthwise direction of the rotation shaft insertion space, so that the pencil is sharpened by the knife blade part.

Preferably, the pencil sharpening part is opened in a side surface direction of the knife blade part, and the pencil sharpener may further include a waste collection part provided in the one side surface direction of the knife blade part so as to collect pencil waste generated as the pencil is sharpened in the knife blade part.

### Advantageous Effects

As described hereinabove, according to the present invention as described above, the pencil sharpener eliminates troublesome operation to fold or rotate the hand and improves the efficiency in operation by implementing simple motion like linear motion in comparison with the conventional portable pencil sharpeners and manual rotary pencil sharpeners.

In addition, the pencil sharpener according to the present invention as described above can sharpen a pencil by rotating the pencil sharpening part through the simple linear motion of pressing the pencil in the axial direction, instead of the conventional method which requires both the actions of pressing a pencil against the repulsive force and turning the knife to sharpen a pencil, such that the number of force to be input can be reduced from two to one.

### BRIEF DESCRIPTION OF THE DRAWINGS

FIG. 1a to FIG. 1h are views for showing a pencil sharpener according to a first embodiment of the present invention.

FIG. 2a to FIG. 2c are views for showing a pencil sharpener according to a second embodiment of the present invention.

FIG. 3a to FIG. 3d are views for showing a pencil sharpener according to a third embodiment of the present invention.

FIG. 4a to FIG. 4c are views for showing a pencil sharpener according to a fourth embodiment of the present invention.

FIG. 5a and FIG. 5b are views for showing a pencil sharpener according to a fifth embodiment of the present invention.

FIG. 6a to FIG. 6c are views for showing a pencil sharpener according to a sixth embodiment of the present invention.

FIG. 7a and FIG. 7b are views for showing a pencil sharpener according to a seventh embodiment of the present invention.

FIG. 8 is a view for showing a pencil sharpener according to an eighth embodiment of the present invention.

FIG. 9 is a view for showing a pencil sharpener according to a ninth embodiment of the present invention.

FIG. 10 is a view for showing a pencil sharpener according to a tenth embodiment of the present invention.

FIG. 11a and FIG. 11b are views for showing a pencil sharpener according to an eleventh embodiment of the present invention, and

FIG. 12 is a view for showing a pencil sharpener according to a twelfth embodiment of the present invention.

### DETAILED DESCRIPTION OF THE PREFERRED EMBODIMENT

For a sufficient understanding of the present invention, its operational advantages, and the objectives attained by the implementation of the present invention, reference should be made to the accompanying drawings and the contents of the drawings, which illustrate preferred embodiments of the present invention

Hereinafter, preferred embodiments of the present invention will be described in detail with reference to the accompanying drawings. Like reference symbols in the drawings denote like elements.

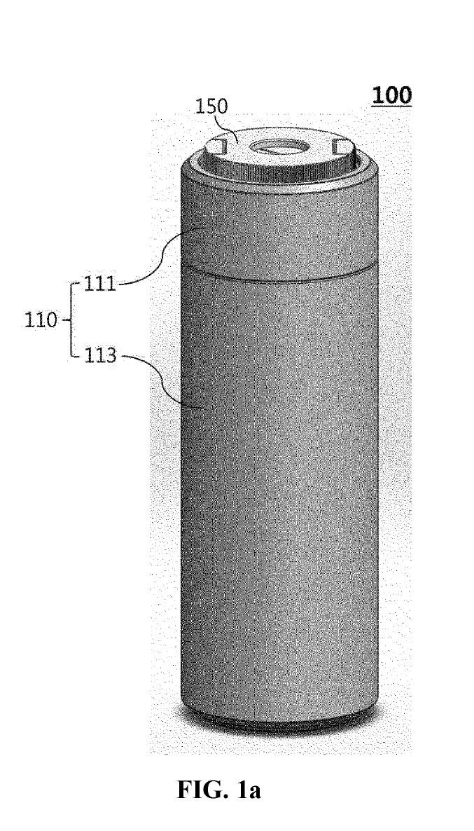

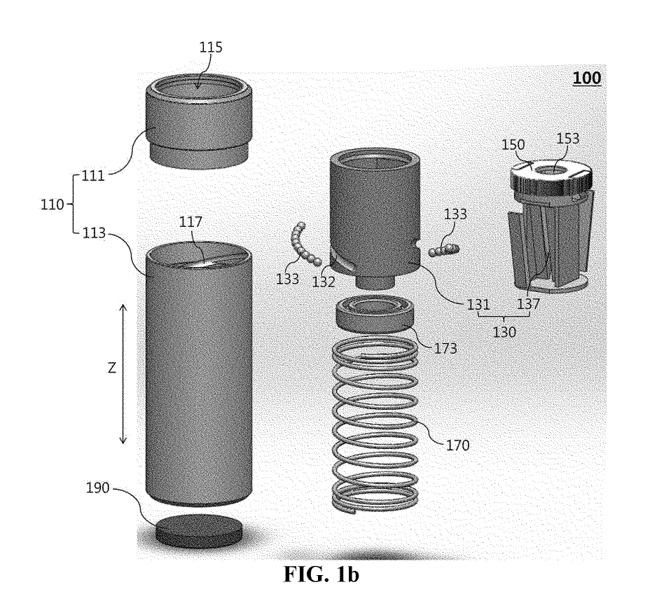

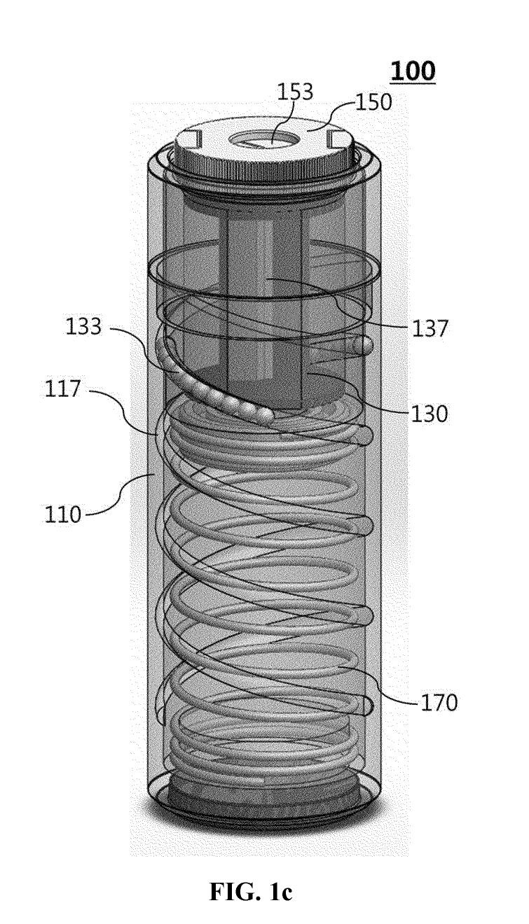

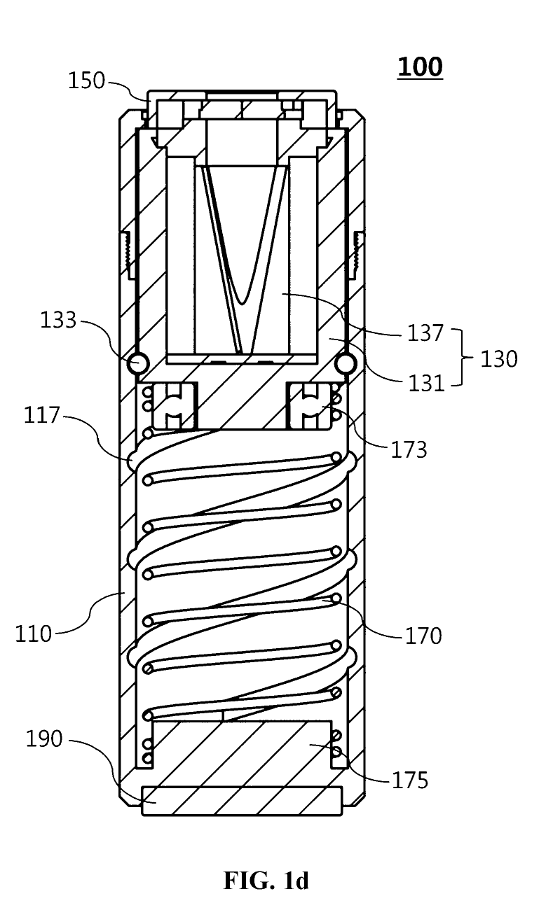

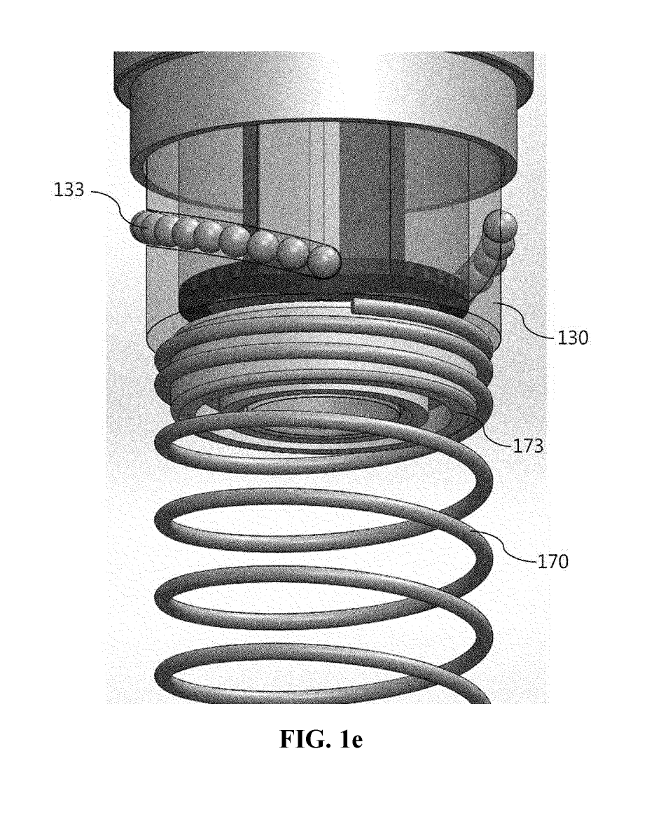

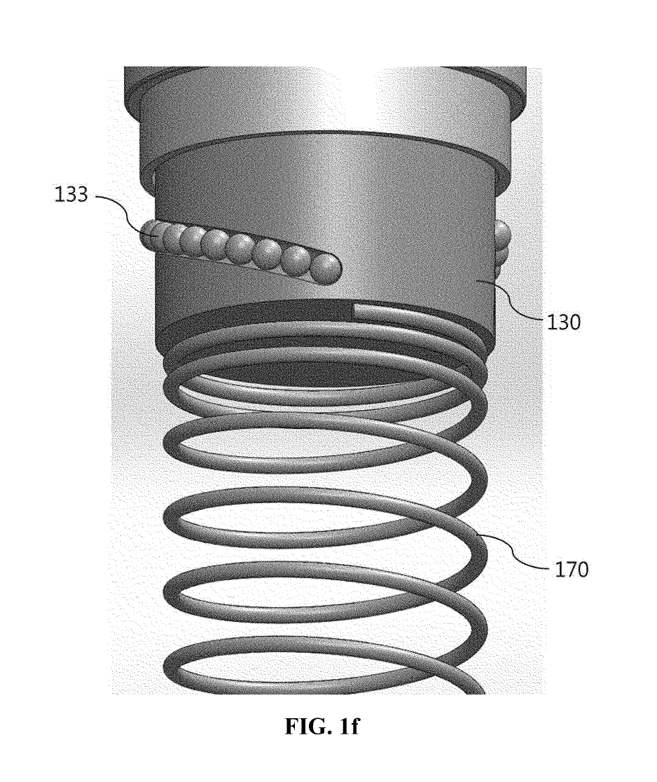

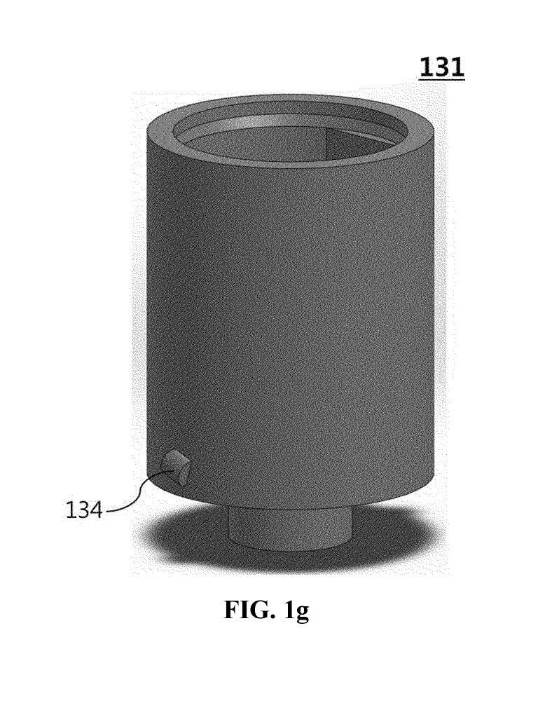

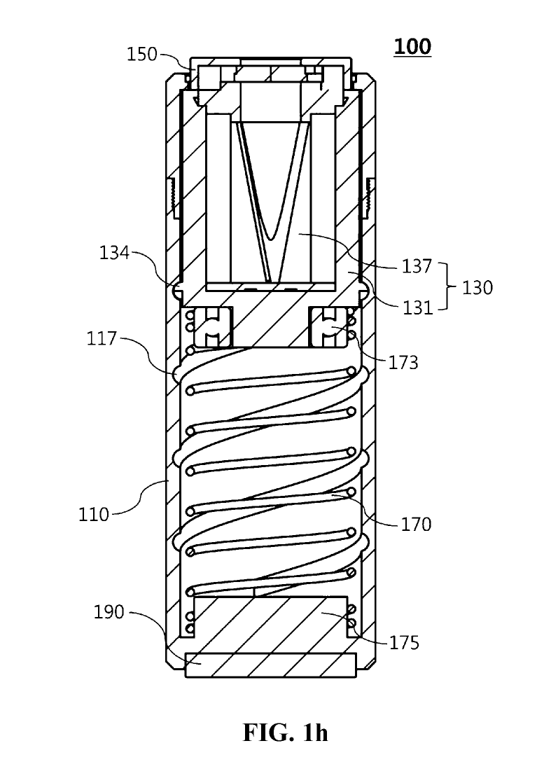

FIG. 1a to FIG. 1h are views for showing a pencil sharpener according to a first embodiment of the present invention.

First, FIG. 1a is a perspective view for showing a pencil sharpener 100 according to the first embodiment of the present invention. Referring to FIG. 1a, the pencil sharpener 100 according to the first embodiment of the present invention may include a housing part 110 and a pencil sharpening part (130 in FIG. 1b) accommodated in the housing part 110. The pencil sharpener 100 may further include a lid part 150 coupled to the opening portion (115 in FIG. 1b), which is formed at the upper end of the housing part 110.

For example, the housing part 110 may include an upper housing 111 and a lower housing 113, wherein the upper housing 111 and the lower housing 113 may be coupled to each other by a thread and a thread groove respectively formed on the coupling portions thereof. For example, the housing part 110 may be formed of various materials such as plastic, metal, and synthetic resin, and the configuration and shape of the housing part 110 may be variously changed.

FIG. 1b is an exploded perspective view for showing the pencil sharpener 100 according to the first embodiment of the present invention. Referring to FIG. 1b, the pencil sharpener 100 according to the first embodiment of the present invention may include the housing part 110 and the pencil sharpening part 130, and further include the lid part 150, a spring part 170, a shock-absorption part 190 and the like.

The housing part 110 may include the upper housing 111 and the lower housing 113, wherein an opening portion 115 may be formed in one surface of the housing part 110, for example, in the top portion of the upper housing 111, and an accommodation space may be formed in the housing part 110. As shown in FIG. 1b, a first coupling member 117 may be formed on the inner surface of the lower housing 113. For example, the first coupling member 117 may be formed as a screw groove in a spiral shape. After sharpening of a pencil is finished, a user can separate the upper housing 111 and the lower housing 113 from each other and then withdraw the pencil sharpening part so as to discharge pencil waste to the outside.

The pencil sharpening part 130 may be inserted into the accommodation space of the housing part 110, and second coupling members 132, 133 corresponding to the first coupling member 117 may be formed on the outer surface of the pencil sharpening part 130. The pencil sharpening part 130 may include a rotation part 131 and a knife blade part 137 provided in the rotation part 131.

The rotation part 131 has the second coupling members 132, 133 formed on the outer surface thereof and may rotate as a pencil, which is inserted into the pencil sharpening part 130 through the lid part 150, carries out linear motion in the lengthwise direction (Z-direction) of the housing part 110. The second coupling members 132, 133 may be formed as at least one protrusion part, wherein the at least one protrusion part may be formed as, for example, an inner groove 132, which is formed in an indented shape on the outer surface of the rotation part 131, and a ball 133 inserted on the inner groove 132. For example, the inclination of the second coupling members 132, 133 may be the same as the inclination of the first coupling member 117, and the shapes of the second coupling members 132, 133 are illustrative and may be variously modified.

The knife blade part 137 may couple to the inside of the rotation part 131 and include at least one fixed blade. The fixed blade may be a fixed type blade used in a normal pencil sharpener and may be arranged diagonally with respect to an inserted pencil as shown in FIG. 1b.

The lid part 150 may be coupled to the upper end of the pencil sharpening part 130 and arranged on the opening portion 115 formed in the housing part 110. A pencil insertion hole 153, into which a pencil is inserted, may be formed in one area of the lid part 150, for example, in the center portion thereof. For example, the pencil insertion hole 153 may be formed in such a manner that the pencil insertion hole 153 is normally closed and can be opened when the lid part 150 is rotated at a predetermined angle for the insertion of a pencil.

The spring part 170 may be arranged at the lower end of the pencil sharpening part 130 and may provide upward restoring force in proportion to the lowering of the pencil sharpening part 130 by a pencil, which is inserted into the pencil sharpening part 130. The pencil sharpener 100, as shown in FIG. 1b, may further include a bearing part 173 arranged between the pencil sharpening part 130 and the spring part 170. A detailed description of the bearing part 173 is omitted herein and will be given with reference to in FIG. 1e hereinafter.

As shown in FIG. 1b, the pencil sharpener 100 may further include a shock-absorption part 190 coupled to the lower end of the housing part 110. The shock-absorption part 190 may be made of a urethane or rubber material that can provide elasticity and can absorb shock when a user places the pencil sharpener 100 on a desk or on the floor and sharpens a pencil.

Meanwhile, according to another embodiment, the shock-absorption part 190 of the pencil sharpener 100may be separated or omitted, such that the lower end portion of the housing part 110 can be opened, wherein the lower end direction of the pencil sharpening part 130 can also be opened. In this case, if a user sharpens a pencil by using the pencil sharpener 100, the pencil waste generated by the pencil sharpening part 130 falls downward so as to be discharged to the outside through the lower end opening portion of the housing part 100. In addition, in some embodiments, the pencil sharpener 100 may include a waste collection part (not shown), instead of the shock-absorption part 190, coupled to the lower end of the housing part 110 such that the pencil waste fallen down by the sharpening of a pencil can be collected in the waste collection part. After sharpening of a pencil is finished, a user can separate the waste collection part from the housing part 110 and then discard the collected pencil waste to the outside. Meanwhile, these embodiments may be similarly applied to pencil sharpeners according to other embodiments described below.

FIG. 1c is a perspective view for showing the projected inside of the pencil sharpener 100 according to the first embodiment of the present invention.

Referring to FIG. 1c, a pencil inserted through the pencil insertion hole 153 of the lid part 150 is inserted into the pencil sharpening part 130 and, when a user pushes the pencil downwards, the pencil sharpening part 130 may carry out linear motion in the lengthwise direction of the housing part 110. Accordingly, at least one area of the pencil sharpening part 130 is rotated by the first coupling member 117 formed on the inner surface of the housing part 110 and the second coupling member 133 formed on the outer surface of the pencil sharpening part 130 such that the pencil may be sharpened by the knife blade part 137 in the pencil sharpening part 130. That is, since the first coupling member 117 formed on the inner surface of the housing part 110 may be a groove formed in a spiral shape and the second coupling member 133 formed on the outer surface of the pencil sharpening part 130 may be a plurality of balls aligned on the spiral line, if a user inserts a pencil into the pencil sharpening part 130 and then pushes the pencil in the downward direction, then the pencil sharpening part 130 carries out rotational motion by the spiral groove. After that, if the user removes the force pushing down the pencil, the pencil sharpening part 130 moves back in the upward direction by the elasticity of the spring part 170, which is coupled to the lower end of the pencil sharpening part 130.

Meanwhile, FIG. 1c illustrates that the second coupling member 133 includes a plurality of balls, but the number of balls included in the second coupling member 133 are illustrative and may be variously changed.

In addition, FIG. 1b and FIG. 1c illustrate that the first coupling member 117 formed on the inner surface of the housing part 110 is implemented as a groove formed in a spiral shape and the second coupling members 132, 133 formed on the outer surface of the pencil sharpening part 130 are implemented as the at least one protrusion part such as the inner groove 132 and the balls 133. However, such configuration is illustrative and, in some embodiments, the first coupling member formed on the inner surface of the housing part 110 may be implemented as the at least one protrusion part such as the inner groove 132 and the balls 133 and the second coupling member formed on the outer surface of the pencil sharpening part 130 may be implemented as a groove formed in a spiral shape such as the screw groove 117. In this case, a plurality of first coupling members formed on the inner surface of the housing part 110 may be provided at various positions for smooth movement of the pencil sharpening part 130.

FIG. 1d is a cross-sectional view for showing the pencil sharpener 100 according to the first embodiment of the present invention.

As shown in FIG. 1d, the pencil sharpening part 130 may include the rotation part 131 and the knife blade part 137, and the fixed blade of the knife blade part 137 may be formed diagonally according to the position of a pencil to be inserted.

In addition, the lower end of the spring part 170 may be coupled to the spring coupling part 175 formed at the lower end of the housing part 110 and the upper end of the spring part 170 may be coupled to the bearing part 173, which is coupled to the pencil sharpening part 130. Since the explanation on the other components is given with reference to FIG. 1a to FIG. 1c, the detailed description thereof will be omitted.

FIG. 1e is a detailed view for showing the bearing part included in the pencil sharpener 100 according to the first embodiment of the present invention.

Referring to FIG. 1e, the bearing part 173 may be coupled to the lower end of the pencil sharpening part 130 and the spring part 170 may be coupled to the outer surface of the bearing part 173. At least one bearing is arranged on the frictional surfaces between the bearing part 173 and the pencil sharpening part 130 so as to reduce frictional force. Accordingly, even though a user rotates the pencil sharpening part 130 so as to sharpen a pencil, the spring part 170 is prevented from rotating but fixed by the action of the bearing part 173. The specific configuration of the bearing part 173 is well known to those of ordinary skill in the art, and thus the detailed description thereof will be omitted.

Meanwhile, even though FIG. 1e shows that the bearing part 173 is coupled to the upper end of the spring part 170, this configuration is illustrative. The bearing part 173 may be arranged at various positions, for example, by being coupled to the lower end of the spring part 170. In addition, it is also conceivable to variously change the shape, in which the spring part 170 encompasses the bearing part 173.

FIG. 1f is a view for showing another embodiment with respect to the pencil sharpener 100 according to the first embodiment of the present invention.

Referring to FIG. 1f, the pencil sharpener 100 according to the first embodiment of the present invention may not include the bearing part 173. That is, as shown in FIG. 1f, it is possible to arrange the spring part 170 in close contact with the lower end of the pencil sharpening part 130. In this case, the spring coupling part 175 is not formed at the lower end of the housing part 110 and the lower end of the spring part 170 is not coupled to the housing part 110 but arranged to be in close contact with the housing part 110.

FIG. 1g and FIG. 1h are views for showing further embodiments with respect to the pencil sharpener 100 according to the first embodiment of the present invention.

Referring to FIG. 1g, the at least one protrusion part provided to the outer surface of the rotation part 131 of the pencil sharpening part 130 may be a protrusion 134 formed to be protruded from the surface. That is, the protrusion 134 may be formed on the outer surface of the rotation part 131, instead of the inner groove 132 and the balls 133 as show in FIG. 1b. The protrusion 134 may have a shape corresponding to the shape of the screw groove 117 formed on the inner surface of the housing part 110 and may be formed in an inclined shape according to the angle of the screw groove 117. FIG. 1h is a cross-sectional view of the pencil sharpener 100 having the protrusion 134 provided on the outer surface of the rotation part 131 of the pencil sharpening part 130, in which since each constituent element has already been described in detail, the detailed description thereof will be omitted.

Meanwhile, the pencil sharpener 100 according to the first embodiment of the present invention may not include the spring part 170, and may include the tension part (not shown) instead of the spring part 170 in some embodiments. The tension part is arranged between the pencil sharpening part 130 and the lid part 150 and can provide upward restoring force in proportion to the lowering of the pencil sharpening part 130 by a pencil, which is inserted into the pencil sharpening part 130. The tension part may be made of a material having tension when pulled at both sides.

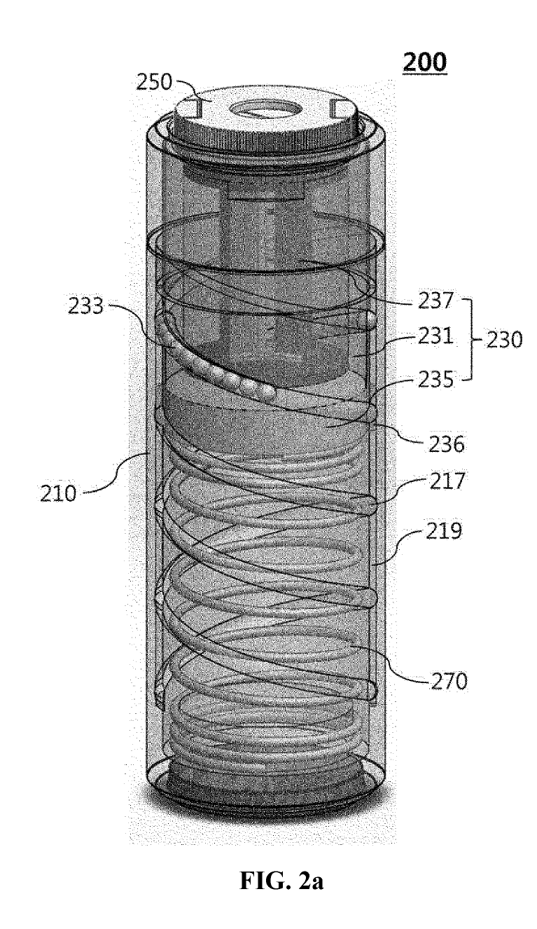

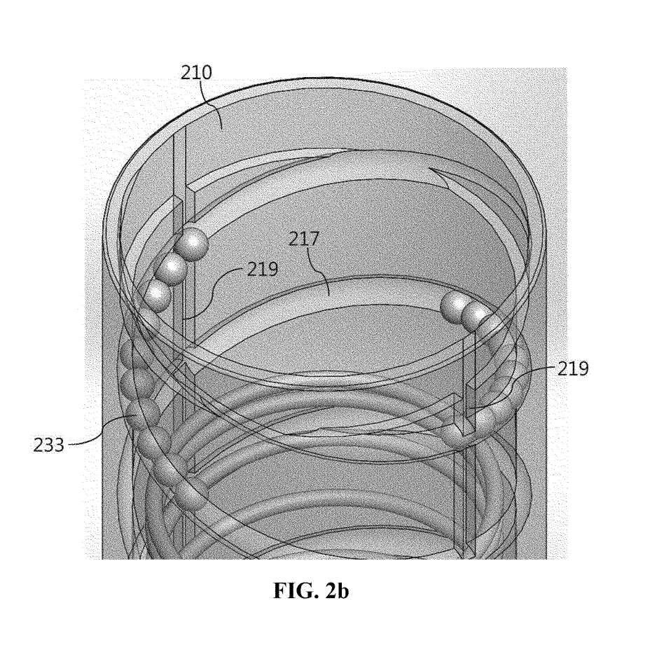

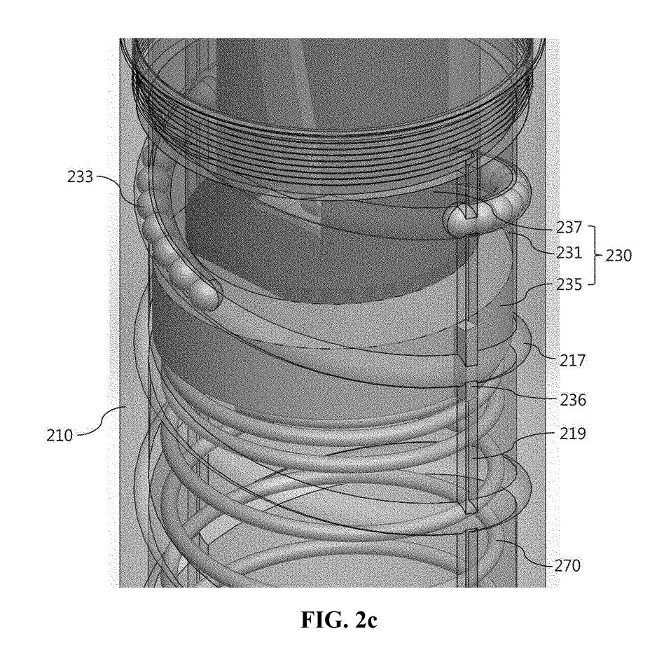

FIG. 2a to FIG. 2c are views for showing a pencil sharpener according to a second embodiment of the present invention.

First, FIG. 2a is a perspective view for showing the projected inside of a pencil sharpener 200 according to the second embodiment of the present invention. Referring to FIG. 2a, the pencil sharpener 200 may include a housing part 210, a pencil sharpening part 230, a lid part 250 and a spring part 270. The pencil sharpener 200 shown in FIG. 2a is similar to the pencil sharpener 100 shown in FIG. 1c except the features of the housing part 210 and the pencil sharpening part 230.

Like the housing part 110 provided in the pencil sharpener 100 shown in FIG. 1a, the housing part 210 may include a first coupling member 217 formed in a spiral groove shape on the inner side of the housing part 210, and may further include a third coupling member 219 additionally formed in a linear shape on the inner side of the housing part 210. The third coupling member 219 may be formed as a groove, which is indented in a linear shape as shown in FIG. 2a, and may be changed into various other shapes.

The pencil sharpening part 230 may include an upper rotation part 231, a lower fixed part 235 and a knife blade part 237, as shown in FIG. 2a. The upper rotation part 231 may have a second coupling member 233 formed on the outer surface thereof and thus can rotate as a pencil, which is inserted into the pencil sharpening part 230, carries out linear motion in the lengthwise direction of the housing part 210. The lower fixed part 235 may be coupled to the lower side of the upper rotation part 231 and may include a fourth coupling member 236 formed on the outer surface thereof and corresponding to the third coupling member 219. For example, the fourth coupling member 236 may be protruded in a rectangular parallelepiped shape and may also be modified into various shapes as far as the fourth coupling member 236 can be inserted into the third coupling member 219. Since the fourth coupling member 236 is inserted into the third coupling member 219, which is in a linear shape, if a user inserts and pushes a pencil, the lower fixed part 235 does not carry out rotational motion but move vertically. To this end, even though not illustrated in FIG. 2a, a bearing (not shown) may be further provided between the upper rotation part 231 and the lower fixed part 235. The bearing can serve to remove the frictional force between the upper rotation part 231, which rotates, and the lower fixed part 235, which does not rotate. Meanwhile, the knife blade part 237 is coupled to the inside of the upper rotation part 231, as shown in FIG. 2a, and may include at least one fixed blade.

FIG. 2b is a view for showing in detail the housing part 210 of the pencil sharpener 200 according to the second embodiment of the present invention and FIG. 2c is a view for showing in detail the coupling relations between the pencil sharpening part 230 and the housing part 210 in the pencil sharpener 200 according to the second embodiment of the present invention.

Referring to FIG. 2b and FIG. 2c, the first coupling member 217 of the spiral shape and the third coupling member 219 of a linear shape may be formed on the inner surface of the housing part 210. As shown in FIG. 2c, in order to prevent the second coupling member 233, which is inserted into the first coupling member 217, from escaping towards the third coupling member 219, the third coupling member 219 may have a transverse width smaller than the size of the second coupling member 233. In addition, in order to prevent the fourth coupling member 236, which is inserted into the third coupling member 219, from escaping towards the first coupling member 217, the fourth coupling member 236 may have a length longer than the width of the first coupling member 217.

In addition, similarly, in order to prevent the interference of the first coupling member 217 with the third coupling member 219, the indented depth of the first coupling member 217 and the indented depth of the third coupling member 219 may be formed to be different from each other, and the second coupling member 233 and the fourth coupling member 236 may be formed at corresponding heights. Besides, it is also possible to modify the first coupling member 217 and the third coupling member 219 as well as the second coupling member 233 and the fourth coupling member 236 respectively corresponding thereto into various shapes.

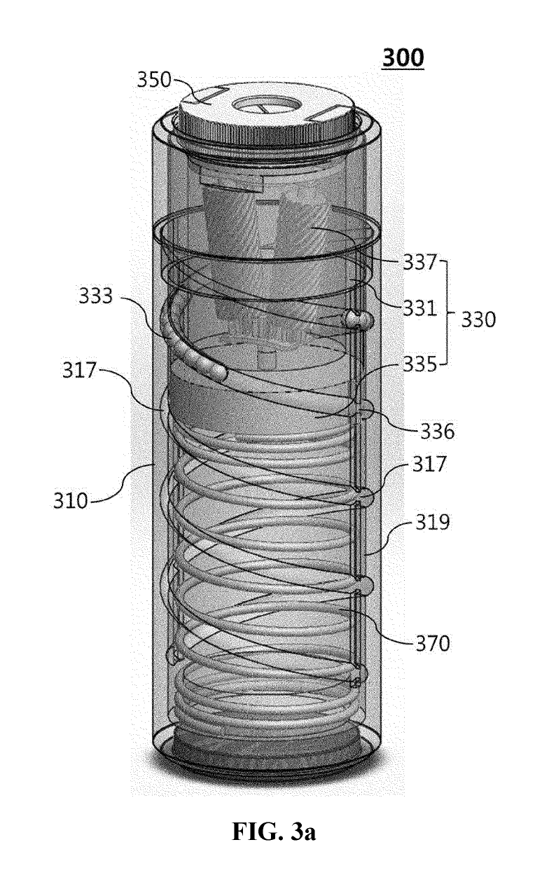

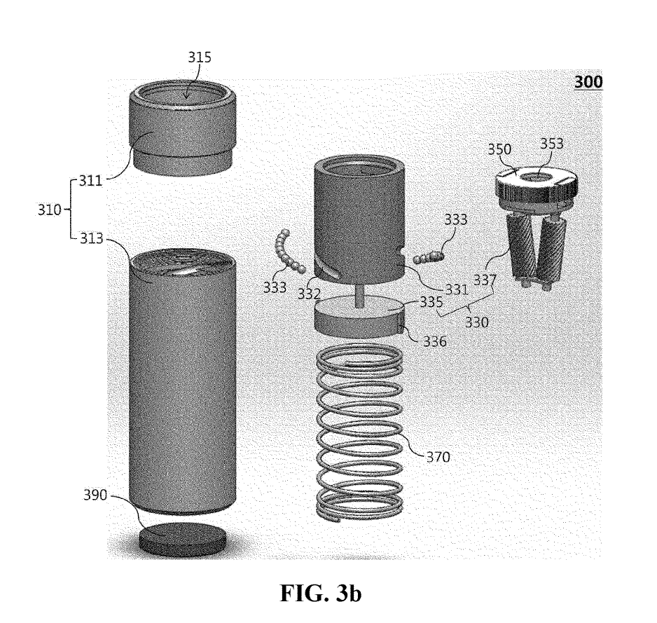

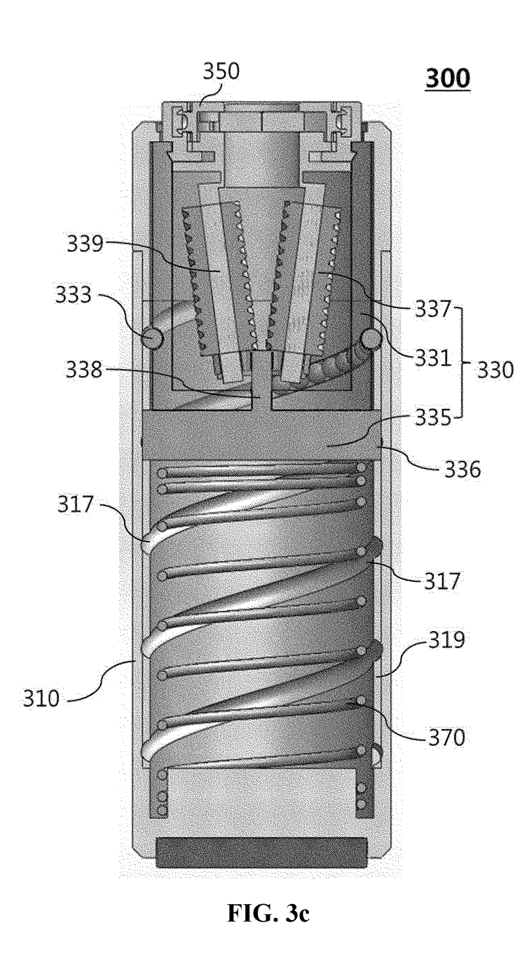

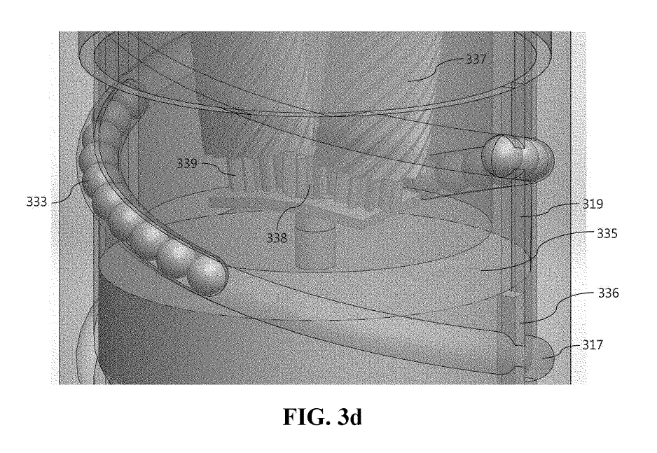

FIG. 3a to FIG. 3d are views for showing a pencil sharpener according to a third embodiment of the present invention.

First, FIG. 3a is a perspective view for showing the projected inside of a pencil sharpener 300 according to the third embodiment of the present invention. Referring to FIG. 3a, the pencil sharpener 300 may include a housing part 310, a pencil sharpening part 330, a lid part 350 and a spring part 370. The pencil sharpener 300 shown in FIG. 3a is similar to the pencil sharpener 200 shown in FIG. 2a except the features of the pencil sharpening part 330.

Like the housing part 210 provided in the pencil sharpener 200 shown in FIG. 2a, the housing part 310 may include a first coupling member 317 of a spiral groove shape and a third coupling member 319 of a linear shape on the inner surface thereof.

The pencil sharpening part 330 may include an upper rotation part 331, a lower fixed part 335 and a knife blade part 337, as shown in FIG. 3a. The upper rotation part 331 may have a second coupling member 333 formed on the outer surface thereof and thus can rotate as a pencil, which is inserted into the pencil sharpening part 330, carries out linear motion in the lengthwise direction of the housing part 310. The lower fixed part 335 may be coupled to the lower side of the upper rotation part 331 and may include a fourth coupling member 336 formed on the outer surface thereof and corresponding to the third coupling member 319. Since the fourth coupling member 336 is inserted into the third coupling member 319, which is in a linear shape, if a user inserts and pushes a pencil, the lower fixed part 335 does not carry out rotational motion but moves vertically in a fixed state. For example, the fourth coupling member 336 may be protruded in a rectangular parallelepiped shape and may also be modified into various shapes as far as the fourth coupling member 336 can be inserted into the third coupling member 319.

Meanwhile, differently from the pencil sharpener 200 shown in FIG. 2a, the knife blade part 337 may include at least one spiral blade. The knife blade part 337 will be described in detail with respect to the specific shape and operation thereof in reference to FIG. 3c and FIG. 3d, and the detailed description thereof will be omitted here.

FIG. 3b is an exploded perspective view for showing the pencil sharpener 300 according to the third embodiment of the present invention. Referring to FIG. 3b, the pencil sharpener 300 according to the third embodiment of the present invention may include the housing part 310 and the pencil sharpening part 330, and further include a lid part 350, a spring part 370, a shock-absorption part 390 and the like.

The housing part 310 may include an upper housing 311 and a lower housing 313, wherein an opening portion 315 may be formed in one surface of the housing part 310, for example, in the top portion of the upper housing 311. In addition, second coupling members 332, 333 may be formed on the outer surface of the upper rotation part 331 and the second coupling members 332, 333 may be formed as at least one protrusion part, wherein the at least one protrusion part may be formed as, for example, an inner groove 332, which is formed in an indented shape on the outer surface of the rotation part 331, and a ball 333 inserted on the inner groove 332. In addition, the lid part 350 may include a pencil insertion hole 353. Since the explanation on any other components than the pencil sharpening part 330 are similar to those shown in FIG. 1b, the detailed description thereof will be omitted.

FIG. 3c is a cross-sectional view for showing the pencil sharpener 300 according to the third embodiment of the present invention and FIG. 3d is a view for showing in detail a spiral blade provided to the pencil sharpener 300 according to the third embodiment of the present invention.

Referring to FIG. 3c and FIG. 3d, if a user inserts and pushes a pencil into the pencil sharpening part 330, the upper rotation part 331 is lowered while rotating and the lower fixed part 335 does not rotate but is lowered in a fixed state. However, as shown in FIG. 3d, since the gear formed on a central shaft 338, which is formed to be extended upwards from the lower fixed part 335, and the gear formed on a blade shaft 339, which penetrates the center of the at least one spiral blade 337, are engaged with each other, when the lower fixed part 335 does not rotate while the upper rotation part 331 rotates, the at least one spiral blade 337 coupled to the upper rotation part 331 moves in a circle around the central shaft 338 and simultaneously rotates about the blade shaft 339 as a central axis thereof. That is, the at least one spiral blade 337 rotates by the interaction between the central shaft 338, which is formed to be extended upwards from the lower fixed part 335, and the blade shaft 339, which penetrates the center of the at least one spiral blade 337. Accordingly, the end of a pencil, which is inserted into the pencil sharpening part 330, can be sharpened.

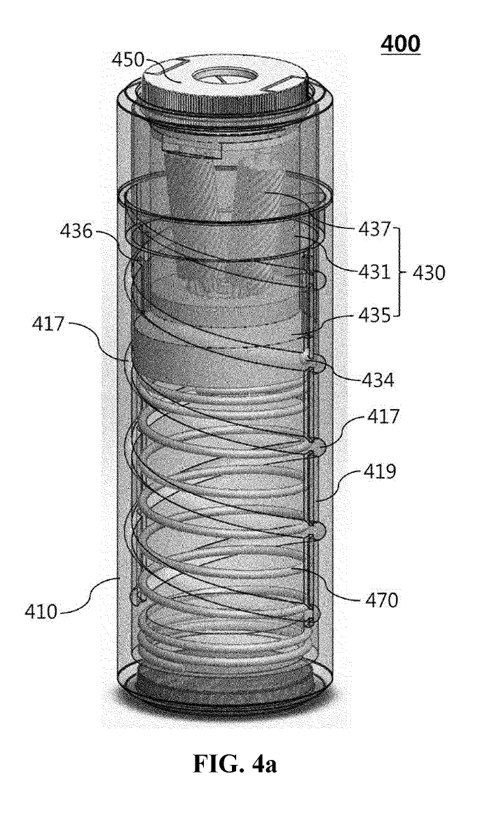

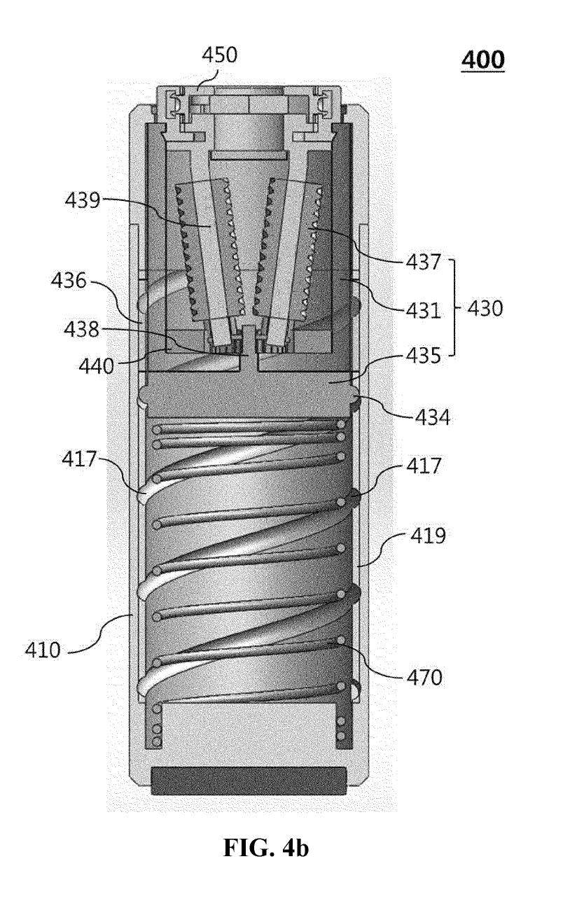

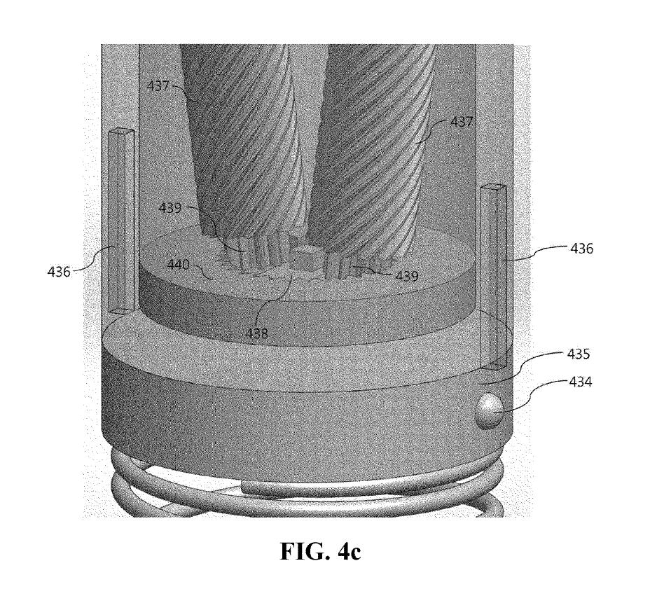

FIG. 4a to FIG. 4c are views for showing a pencil sharpener according to a fourth embodiment of the present invention.

First, FIG. 4a is a perspective view for showing the projected inside of a pencil sharpener 400 according to the fourth embodiment of the present invention. Referring to FIG. 4a, the pencil sharpener 400 may include a housing part 410, a pencil sharpening part 430, a lid part 450 and a spring part 470. The pencil sharpener 400 shown in FIG. 4a is similar to the pencil sharpener 300 shown in FIG. 3a except the features of the pencil sharpening part 430.

Like the housing part 310 provided in the pencil sharpener 300 shown in FIG. 3a, the housing part 410 may include a first coupling member 417 of a spiral groove shape and a third coupling member 419 of a linear shape on the inner surface thereof.

The pencil sharpening part 430 may include an upper fixed part 431, a lower rotation part 435 and a knife blade part 437, as shown in FIG. 4a. The upper fixed part 431 may be coupled to the upper side of the lower rotation part 435 and may include a fourth coupling member 436 formed on the outer surface thereof and corresponding to the third coupling member 419. Since the fourth coupling member 436 is inserted into the third coupling member 419, which is in a linear shape, if a user inserts and pushes a pencil, the upper fixed part 431 does not carry out rotational motion but moves vertically in a fixed state. The lower rotation part 435 may have a second coupling member 434 formed on the outer surface thereof and, accordingly, can rotate as a pencil, which is inserted into the pencil sharpening part 430, carries out linear motion in the lengthwise direction of the housing part 410.

Meanwhile, similarly to the pencil sharpener 300 shown in FIG. 3a, the knife blade part 437 may include at least one spiral blade. The knife blade part 437 will be described in detail with respect to the operation thereof in reference to FIG. 4b and FIG. 4c, and the detailed description thereof will be omitted here.

FIG. 4b is a cross-sectional view for showing the pencil sharpener 400 according to the fourth embodiment of the present invention, and FIG. 4c is a view for showing in detail the spiral blade provided to the pencil sharpener 400 according to the fourth embodiment of the present invention.

Referring to FIG. 4b and FIG. 4c, if a user inserts and pushes a pencil into the pencil sharpening part 430, the upper fixed part 431 does not rotate but is lowered in a fixed state while the lower rotation part 435 rotates and is lowered. However, as shown in FIG. 4b and FIG. 4c, since the gear formed on the inside of a circular plate 440, which is coupled to a central shaft 438, which is formed to be extended upwards from the lower fixed part 435, and the gear formed on a blade shaft 439, which penetrates the center of the at least one spiral blade 437, are engaged with each other, when the upper fixed part 431 does not rotate while the lower rotation part 435 rotates, the at least one spiral blade 437 coupled to the upper fixed part 431 rotates about the blade shaft 439 as a central axis thereof. That is, the at least one spiral blade 437 rotates by the interaction between the central shaft 438, which is formed to be extended upwards from the lower rotation part 435, and the blade shaft 439, which penetrates the center of the at least one spiral blade 437. Accordingly, the end of a pencil, which is inserted into the pencil sharpening part 430, can be sharpened.

Meanwhile, FIG. 4c illustrates that the second coupling member 434 is formed in a protrusion shape. However, such configuration is illustrative and the second coupling member 434 may be implemented in various shapes such as the shapes of the inner groove 332 and the balls 333 shown in FIG. 3b and the like.

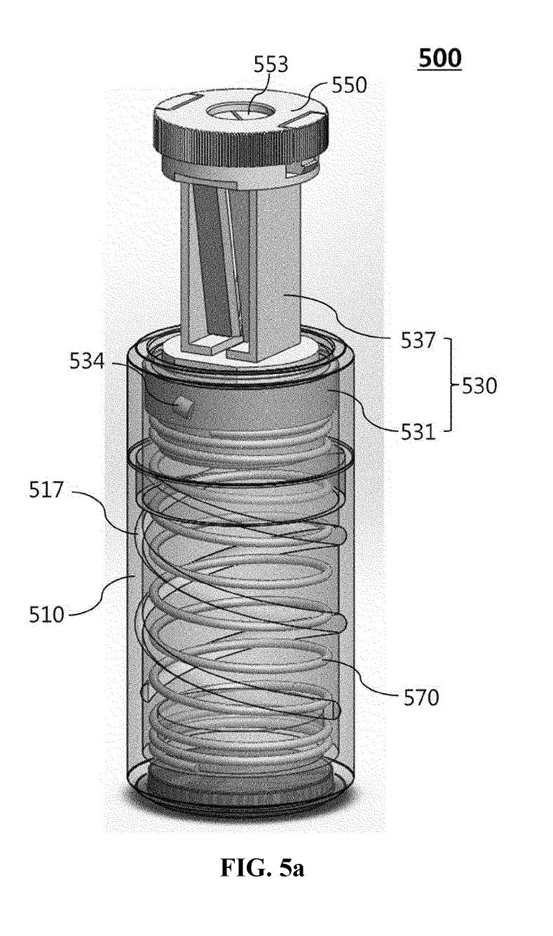

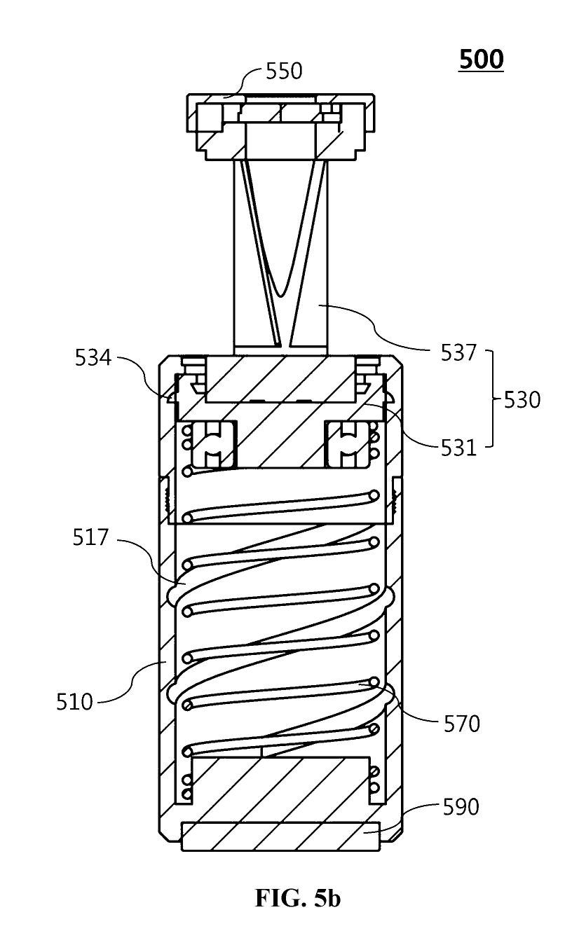

FIG. 5a and FIG. 5b are views for showing a pencil sharpener according to a fifth embodiment of the present invention. First, FIG. 5a is a perspective view for showing the projected inside of a pencil sharpener 500 according to the fifth embodiment of the present invention, and FIG. 5b is a cross-sectional view for showing the pencil sharpener 500 according to the fifth embodiment of the present invention.

The pencil sharpener 500 shown in FIG. 5a and FIG. 5b is similar to the pencil sharpener 100 described in reference to FIG. 1c with respect to the features thereof but differs from the latter in that a housing part 510 is short in length and a pencil sharpening part 530 is exposed to the outside.

The pencil sharpening part 530 may include a lower rotation part 531 and a knife blade part 537. The lower rotation part 531 has a second coupling member 534 formed on the outer surface thereof and, accordingly, can rotate as a pencil, which is inserted into the pencil sharpening part 530, carries out linear motion in the lengthwise direction of the housing part 510.

The knife blade part 537 may include at least one fixed blade, which is fixed and coupled to the upper side of the lower rotation part 531 and, as shown in FIG. 5a, may be opened at a side surface portion and protruded to the outside of the housing part 510.

Therefore, the pencil sharpener 500 according to the fifth embodiment of the present invention, as shown in FIG. 5a and FIG. 5b, has effect that pencil waste, which is discharged from the knife blade part 537 in the process of sharpening a pencil, can be discharged through the opened side surface of the knife blade part 537.

FIG. 5a shows that the whole side surface of the knife blade part 537 is opened, but this configuration is illustrative. Therefore, it is possible to form the pencil sharpener 500 according to the fifth embodiment of the present invention by opening a portion of the side surface of the knife blade part 537 and forming an additional housing for the other portions of the side surface of the knife blade part 537. Meanwhile, FIG. 5a illustrates that the second coupling member 534 is formed in a protrusion shape. However, such configuration is illustrative and the second coupling member 534 may be implemented in various shapes such as the shapes of the inner groove 332 and the balls 333 shown in FIG. 3b and the like.

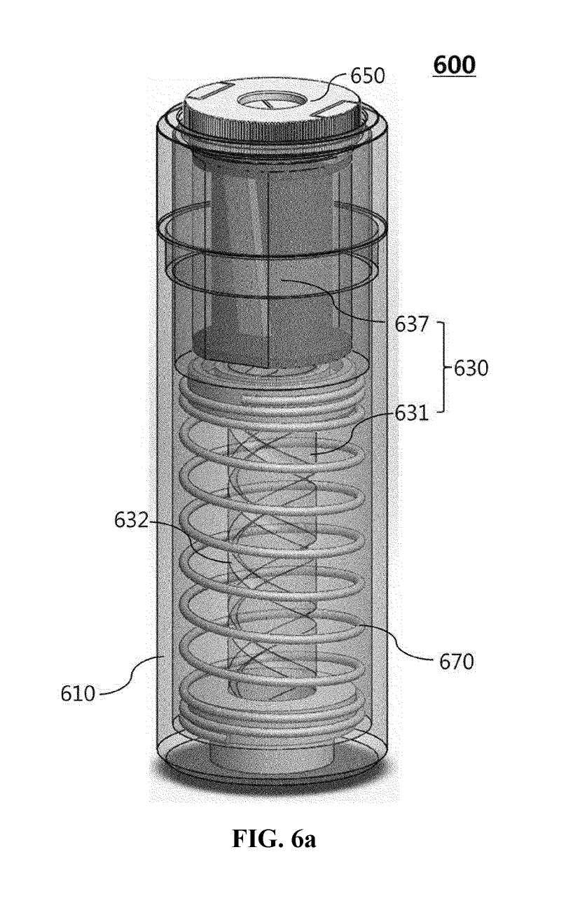

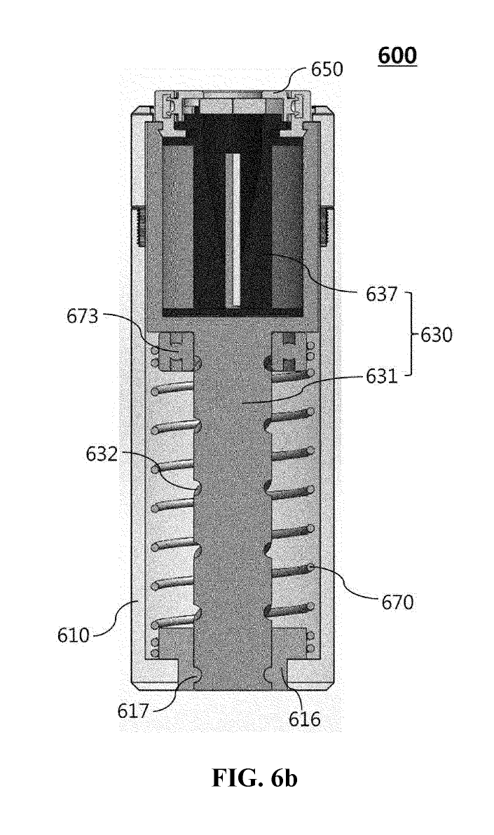

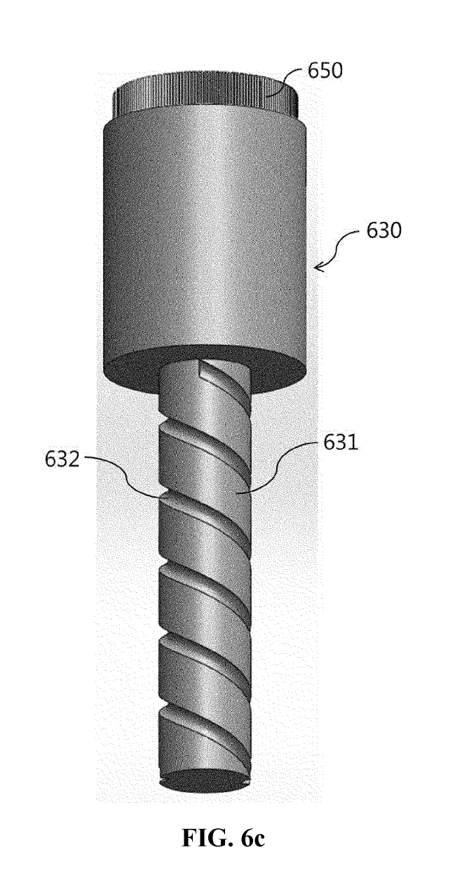

FIG. 6a to FIG. 6c are views for showing a pencil sharpener according to a sixth embodiment of the present invention.

First, FIG. 6a is a perspective view for showing the projected inside of a pencil sharpener 600 according to the sixth embodiment of the present invention. Referring to FIG. 6a, the pencil sharpener 600 may include a housing part 610, a pencil sharpening part 630, a lid part 650 and a spring part 670. Detailed description of each of the features will be given in reference to FIG. 6b.

FIG. 6b is a cross-sectional view for showing the pencil sharpener 600 according to the sixth embodiment of the present invention. Referring to FIG. 6b, the housing part 610 may include an upper end opening portion formed at the upper side thereof such that the lid part 650 may be coupled to the upper end opening portion, and a lower end opening portion 616 formed at the opposite side of the upper end opening portion. A first coupling member 617 may be formed on the inner surface of the lower end opening portion 616, and the first coupling member 617 may be formed as a protrusion or at least one protrusion part such as an inner groove and balls.

The pencil sharpening part 630 may be inserted to the inside of the accommodation space of the housing part 610 and include a rotation shaft part 631 and a knife blade part 637. The rotation shaft part 631 may be coupled to the lower end of the knife blade part 637 and, as shown in FIG. 6b, may be extended from the knife blade part 637 to the lower end opening portion 616. The rotation shaft part 631 may include a second coupling member 632 formed on the outer surface thereof and corresponding to the first coupling member 617, and the second coupling member 632 may be formed as a screw groove in a spiral shape. The knife blade part 637 may include at least one fixed blade, which is fixed and coupled to the upper portion of the rotation shaft part 631.

Referring to FIGS. 6a and 6b, if a pencil, which is inserted through the lid part 650, is inserted into the pencil sharpening part 630 and a user inserts and pushes the pencil downwards, the pencil sharpening part 630 can carry out linear motion in the lengthwise direction of the housing part 610.

Accordingly, the pencil sharpening part 630 is rotated by the first coupling member 617 formed on the inner surface of the lower end opening portion 616 and the second coupling member 632 formed on the outer surface of the rotation shaft part 631 such that the pencil can be sharpened by the knife blade part 637 in the pencil sharpening part 630.

The lower end of the spring part 670 may be coupled to the upper side of the lower end opening portion 616, and the upper end of the spring part 670 may be coupled to a bearing part 673, which is coupled to the pencil sharpening part 630. Since the operation of the spring part 670 is similar to the corresponding one of the above-mentioned embodiment, the detailed description thereof is omitted.

FIG. 6c is a view for showing in detail the pencil sharpening part 630 provided to the pencil sharpener 600 according to the sixth embodiment of the present invention. As shown in FIG. 6c, the rotation shaft part 631 included in the pencil sharpening part 630 may be formed in a cylindrical shape and may include the screw groove 632 formed in a spiral shape on the outer surface thereof.

Meanwhile, FIG. 6a to FIG. 6c illustrate that the first coupling member 617 formed on the inner surface of the lower end opening portion 616 is implemented as at least one protrusion part such as a protrusion and the second coupling member 632 formed on the outer surface of the rotation shaft part 631 is implemented as the screw groove in a spiral shape. However, such configuration is illustrative and, in some embodiments, the first coupling member 617 formed on the inner surface of the lower end opening portion 616 may be implemented as the screw groove in a spiral shape and the second coupling member 632 formed on the outer surface of the rotation shaft part 631 may be implemented as the at least one protrusion part such as a protrusion or balls. In this case, a plurality of second coupling member 632 formed on the outer surface of the rotation shaft part 631 may be provided at various positions for smooth movement of the pencil sharpening part 630.

Meanwhile, the shape of the knife blade part 637 in the pencil sharpener 600 according to the sixth embodiment of the present invention, described above in reference to FIG. 6a to FIG. 6c, may be modified to a spiral blade instead of the fixed blade. In this case, the pencil sharpening part 630 may further include an upper fixed part (not shown), which is coupled to the upper side of the rotation shaft part 631, and the knife blade part 637 may be coupled to the inside of the upper fixed part (not shown) and include at least one spiral blade, which rotates by the interaction between a central shaft formed to be extended from the rotation shaft part 631 and a blade shaft. That is, the present embodiment is similar to the pencil sharpener 400 according to the fourth embodiment of the present invention, described above in reference to FIG. 4a to FIG. 4c, in which the housing part 410 is formed with the lower end opening portion and the rotation shaft part 631 is additionally formed in the lower rotation part 435.

For example, if a user inserts and pushes a pencil into the pencil sharpening part 630, the upper fixed part does not rotate but is lowered in a fixed state while the rotation shaft part 631 rotates and is lowered. However, as mentioned in reference to FIG. 4a to FIG. 4c, if the upper fixed part does not rotate while the rotation shaft part 631 rotates, then the at least one spiral blade coupled to the upper fixed part is rotated with respect to the blade shaft. That is, as a pencil inserted into the pencil sharpening part 630 carries out linear motion in the lengthwise direction of the housing part 610, the rotation shaft part 631 rotates by the first coupling member 617 and the second coupling member 632 such that the end of the pencil inserted into the pencil sharpening part 630 can be sharpened by the knife blade part 637.

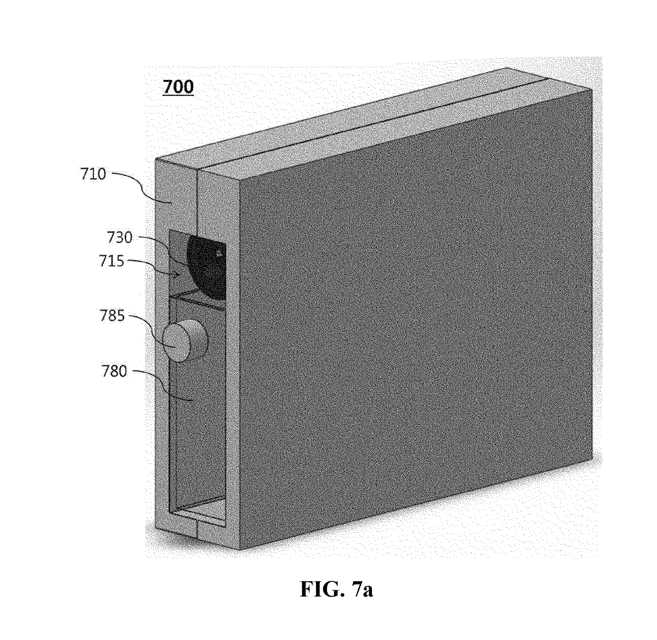

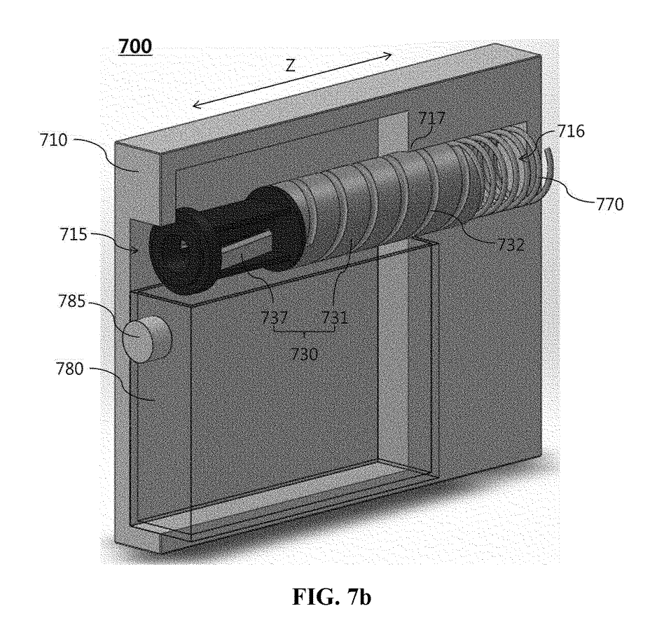

FIG. 7a and FIG. 7b are views for showing a pencil sharpener according to a seventh embodiment of the present invention. FIG. 7a is a perspective view for showing a pencil sharpener 700 according to the seventh embodiment of the present invention, and FIG. 7b is a cross-sectional view for showing the inside of the pencil sharpener 700 according to the seventh embodiment of the present invention.

Referring to FIG. 7a and FIG. 7b, the pencil sharpener 700 may include a housing part 710 and a pencil sharpening part 730, and further include a spring part 770 and a waste collection part 780 in some embodiments.

The housing part 710 may be formed in a rectangular parallelepiped shape and have an opening portion 715 formed in one surface, into which a pencil is inserted, and an accommodation space may be formed in the housing part 710. As shown in FIG. 7b, a rotation shaft insertion space 716 may be formed in one area of the accommodation space such that a rotation shaft part 731 may be inserted thereinto. Even though not explicitly shown in FIG. 7b, a first coupling member 717 may be formed in the shape of a protrusion or a ball on the inner surface of the rotation shaft insertion space 716.

The pencil sharpening part 730 may be inserted into the accommodation space of the housing part 710, and include a rotation shaft part 731 and a knife blade part 737. The rotation shaft part 731 may be coupled to one side surface of the knife blade part 737 and have a second coupling member 732 formed on the outer surface thereof. The second coupling member 732 may be formed in a shape corresponding to that of the first coupling member 717. For example, the second coupling member 732 may be the screw groove in a spiral shape as shown in FIG. 7b. The knife blade part 737 may be coupled to one side surface of the rotation shaft part 731, include a fixed blade therein, and be opened in a side surface direction as shown in FIG. 7b.

According to the pencil sharpener 700 shown in FIG. 7, in the similar way as mentioned above in reference to FIG. 6a to FIG. 6c, the rotation shaft part 731 rotates by the first coupling member 717 and the second coupling member 732 as a pencil, which is inserted into the pencil sharpening part 730, carries out linear motion in the lengthwise direction (Z-direction) of the rotation shaft insertion space 716, such that the end of the pencil inserted into the pencil sharpening part 730 can be sharpened by the knife blade part 737.

The waste collection part 780 may be formed in the one side surface direction of the knife blade part 737 and collect pencil waste generated while a pencil is sharpened in the knife blade part 737. The waste collection part 780 may be formed in a rectangular parallelepiped shape with an opened top part, include a handle part 785 for the convenience of users, and be formed of a transparent material so as to enable the observation of the inside. It is possible to variously modify the materials and shapes of the housing part 710 and the waste collection part 780.

Meanwhile, it is possible the substitute the features of the first coupling member 717 and the second coupling member 732 with each other. In addition, it is also possible to form the pencil sharpeners 100, 200, 300, 400, 500, 600 according to the above-mentioned embodiments of the present invention similarly to the pencil sharpener 700 according to the seventh embodiment of the present invention described above in reference to FIG. 7a and FIG. 7b such that the knife blade part may be opened in a side surface direction and the waste collection part 780 as shown in FIG. 7b may be further provided.

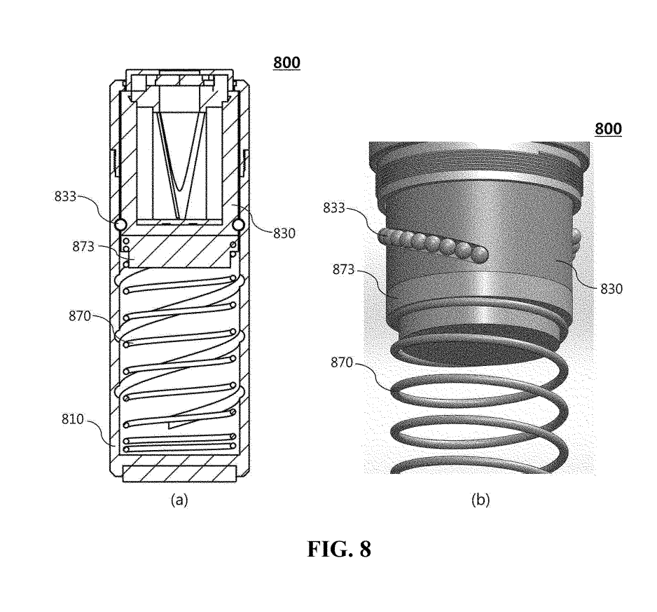

FIG. 8 is a view for showing a pencil sharpener according to an eighth embodiment of the present invention. The drawing (a) of FIG. 8 shows a cross-sectional view of a pencil sharpener 800 according to the eighth embodiment of the present invention, and the drawing (b) of FIG. 8 shows the coupling shape of a spring part 870 in detail. Referring to FIG. 8, the pencil sharpener 800 according to the eighth embodiment of the present invention is generally similar to the pencil sharpener 100 according to the first embodiment of the present invention described above in reference to FIG. 1d, but may differ from the latter in terms of the coupling shape of the spring part 870.

As shown in the drawing (a) of FIG. 8, the lower end of the spring part 870 may not be coupled to any other feature but arranged in close contact with the lower end of the housing part 810. The upper end of the spring part 870 may be coupled to a spring upper coupling part 873 as shown in the drawing (b) of FIG. 8. The spring upper coupling part 873 may come into close contact with the pencil sharpening part 830 at the upper side thereof in a sliding manner. That is, since the top surface of the upper coupling part 873 of the spring part 870 may be formed of a material having low frictional force, the spring upper coupling part 873 may naturally slide as the pencil sharpening part 830 rotates. In this manner, the spring part 870 is arranged at the lower portion of the pencil sharpening part 830 so as to provide upward restoring force.

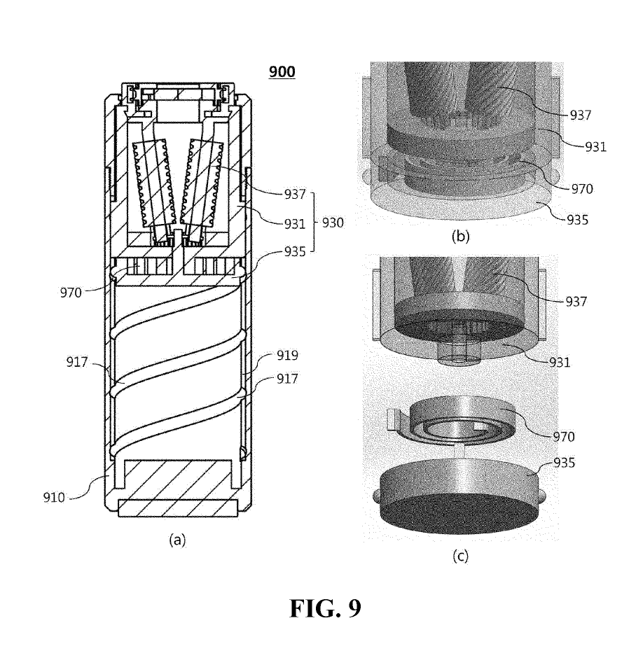

FIG. 9 is a view for showing a pencil sharpener according to a ninth embodiment of the present invention. The drawing (a) of FIG. 9 shows a cross-sectional view of a pencil sharpener 900 according to the ninth embodiment of the present invention, the drawing (b) of FIG. 9 shows a spring part 970 in detail, and the drawing (c) of FIG. 9 is an exploded perspective view of the spring part 970. Referring to FIG. 9, the pencil sharpener 900 according to the ninth embodiment of the present invention is generally similar to the pencil sharpener 400 according to the fourth embodiment of the present invention described above in reference to FIG. 4b, but may differ from the latter in terms of the features of the spring part 970.

As shown in the drawing (a) of FIG. 9, the spring part 970 of the pencil sharpener 900 may be formed as a spiral spring instead of a normal spring. That is, as shown in the drawing (b) of FIG. 9 and the drawing (c) of FIG. 9, the spring part 970 formed as a spiral spring may be coupled between a lower rotation part 935 and an upper fixed part 931. If a user inserts and pushes a pencil into a pencil sharpening part 930, the lower rotation part 935 rotates while the pencil sharpening part 930 is lowered. At this time, restoring force is applied in the opposite direction from the rotation direction of the lower rotation part 935 according to the elasticity of the spring part 970 formed as the spiral spring. Therefore, if the pressing force of the user is released from the pencil, the lower rotation part 935 naturally rotates and then lifts again.

Meanwhile, it is also possible to modify the spring parts included in the pencil sharpeners of the above-mentioned various embodiments into the shapes of the spring parts 870, 970 mentioned above in reference to FIG. 8 and FIG. 9.

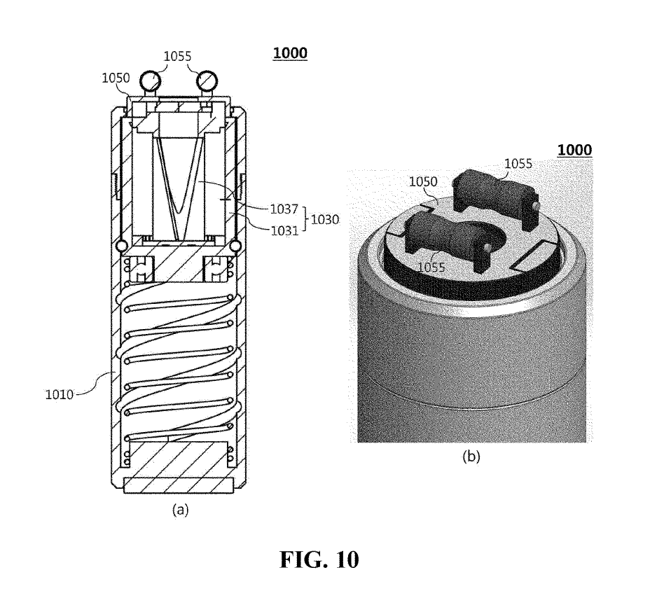

FIG. 10 is a view for showing a pencil sharpener according to a tenth embodiment of the present invention. The drawing (a) of FIG. 10 shows a cross-sectional view of a pencil sharpener 1000 according to the tenth embodiment of the present invention, and the drawing (b) of FIG. 10 shows a lid part 1050 of the pencil sharpener 1000 according to the tenth embodiment of the present invention in detail.

Referring to FIG. 10, the pencil sharpener 1000 according to the tenth embodiment of the present invention is generally similar to the pencil sharpener 100 according to the first embodiment of the present invention described above in reference to FIG. 1d, but may differ from the latter in terms of the features of the lid part 1050.

The lid part 1050 may be coupled to an opening portion of a housing part 1010 and include a pencil insertion hole 1053, into which a pencil is inserted, and at least one roller part 1055. The at least one roller part 1055 may be arranged around the pencil insertion hole 1053, as shown in the drawing (b) of FIG. 10, and prevent the shaking of the pencil during the insertion motion of the pencil by coming into close contact with the surface of the pencil inserted into the pencil insertion hole 1053. To this end, the center portion of the at least one roller part 1055 may be formed in a curvedly indented shape and a central shaft thereof may be coupled to both side column parts so as to rotate according to the insertion of a pencil. The lid part 1050 may be separated from the pencil sharpening part 1030 and coupled to the housing part 1010 since the lid part 1050 should not rotate together with the pencil sharpening part 1030 when the pencil sharpening part 1030 rotates

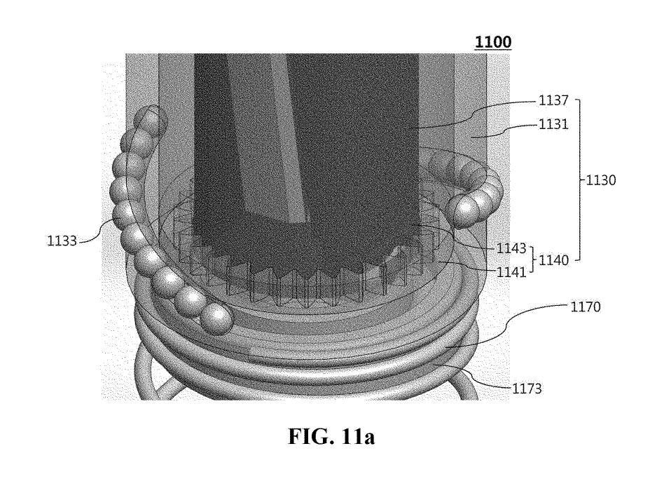

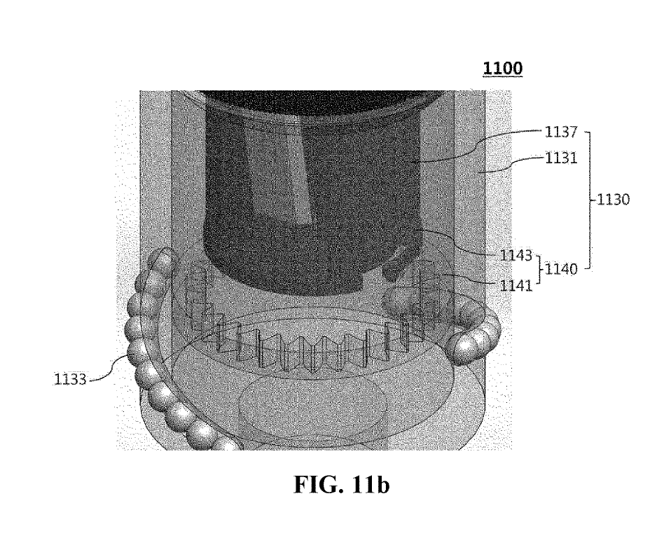

FIG. 11a and FIG. 11b are views for showing a pencil sharpener according to an eleventh embodiment of the present invention. FIG. 11a is a view for showing in detail a ratchet part 1140 provided to a pencil sharpener 1100 according to the eleventh embodiment of the present invention, and FIG. 11b is an exploded perspective view of the ratchet part 1140. The pencil sharpener 1100 shown in FIG. 11a and FIG. 11b is generally similar to the pencil sharpener 100 according to the first embodiment of the present invention described above in reference to FIG. 1d, but may differ from the latter in terms of the features of a pencil sharpening part 1130.

Referring to FIG. 11a and FIG. 11b, the pencil sharpening part 1130 may include a rotation part 1131, a knife blade part 1137 and the ratchet part 1140.

The rotation part 1131 may include a second coupling member 1133 formed on the outer surface thereof so as to rotate as a pencil, which is inserted into the pencil sharpening part 1130, carries out linear motion in the lengthwise direction of a housing part (not shown).

The knife blade part 1137 may be coupled to the ratchet part 1140 and include at least one fixed blade, which is fixed and coupled therein.

The ratchet part 1140 may be coupled between the rotation part 1131 and the knife blade part 1137, wherein, when rotation part 1131 rotates in a first direction, the knife blade part 1137 can also rotate in the first direction while when the rotation part 1131 rotates in a second direction, the knife blade part 1137 is prevented from rotating in the second direction. For example, the first direction may be the counterclockwise direction and the second direction may be the clockwise direction.

As shown in FIG. 11b, the ratchet part 1140 may include a ratchet wheel 1141 and a stopper 1143. The ratchet wheel 1141 may include a gear-shaped groove formed on the inner surface thereof and may be coupled to the rotation part 1131. In addition, the stopper 1143 is held on the ratchet wheel 1141 when the ratchet wheel 1141 rotates in the counterclockwise direction as shown in FIG. 11b. When the ratchet wheel 1141 rotates in the clockwise direction, the stopper 1143 is not held on the ratchet wheel 1141 and can move through the gear-shaped grooves. The stopper 1143 may be coupled to the lower end of the knife blade part 1137.

Therefore, if a user inserts and pushes a pencil into the pencil sharpening part 1130, the rotation part 1131 rotates in the counterclockwise direction by the spiral shape of the first coupling member 1133. In this case, since the stopper 1143 is held on the gear portion of the ratchet wheel 1141, the knife blade part 1137 also rotates in the counterclockwise direction. To the contrary, if the pencil sharpening part 1130 lifts again, since the rotation part 1131 rotates in the clockwise direction and the stopper 1143 is not held on the ratchet wheel 1141 but moves through the gear-shaped grooves, the knife blade part 1137 is prevented from rotating in the clockwise direction. Therefore, the pencil sharpener 1100 can improve the convenience of users since the pencil is sharpened while the knife blade part 1137 rotates if a user pushes a pencil downwards and the knife blade part 1137 is prevented from rotating reversely when the pencil sharpening part 1130 lifts upwards again.

Meanwhile, it is also possible to further provide the ratchet part 1140 shown in FIG. 11a and FIG. 11b to the above-mentioned various embodiments, wherein the shape of the ratchet part 1140 as mentioned above is illustrative and may be modified into various other shapes.

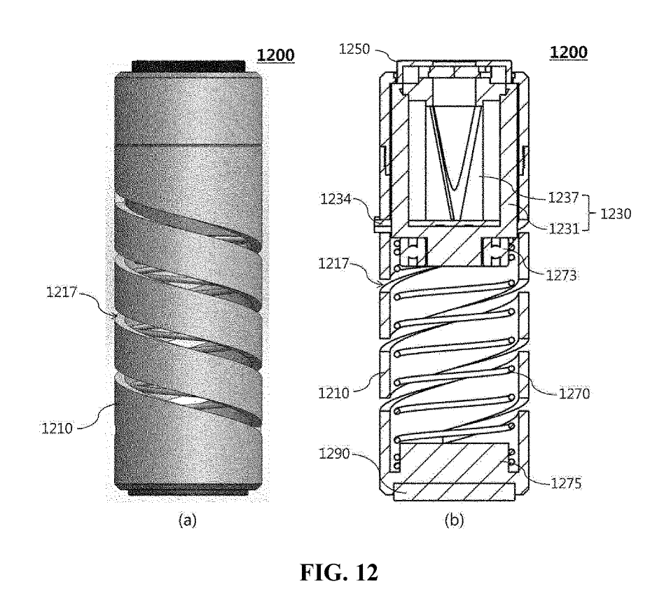

FIG. 12 is a view for showing a pencil sharpener according to a twelfth embodiment of the present invention. The drawing (a) of FIG. 12 is a perspective view showing a pencil sharpener 1200 according to the twelfth embodiment of the present invention, and the drawing (b) of FIG. 12 is a cross-sectional view for showing the pencil sharpener 1200 according to the twelfth embodiment of the present invention. The pencil sharpener 1200 shown in FIG. 12 is generally similar to the pencil sharpener 100 according to the first embodiment of the present invention described above in reference to FIG. 1d, but may differ from the latter in terms of the features of a housing part 1210 and a pencil sharpening part 1230.

First, referring to the drawing (a) of FIG. 12, a first coupling member 1217 provided to the housing part 1210 may be formed in a penetration hole. In addition, referring to the drawing (b) of FIG. 12, a second coupling member 1234 formed on the outer surface of the pencil sharpening part 1230 may be implemented as a protrusion so as to be protruded to the outside by penetrating the first coupling member 1217, which is formed as a penetration hole. The pencil sharpener 1200 has the effect of enabling a user to visually confirm the rotational motion of the pencil sharpening part 1230 when the user sharpens a pencil.

Meanwhile, the pencil sharpeners according to the embodiments of the present invention as described above may be variously combined with each other. Although the present invention has been described with reference to the embodiments shown in the drawings, it would be understood by those skilled in the art that the described embodiments are to be considered in all respects only as illustrative and various changes and any other equivalent modifications may be made therefrom. Therefore, the true scope of the present invention should be determined by the technical idea of the appended claims.

1-20. (canceled)

21. A pencil sharpener comprising:
a housing part having an opening portion formed at one surface portion, an accommodation space formed therein, and a first coupling member formed on an inner surface; and
a pencil sharpening part inserted into the accommodation space of the housing part, and having a second coupling member formed on an outer surface thereof and corresponding to the first coupling member, and a knife blade part provided therein,
wherein at least one area of the pencil sharpening part is rotated by the first coupling member and the second coupling member as a pencil, which is inserted into the pencil sharpening part, carries out linear motion in the lengthwise direction of the housing part, so that the pencil is sharpened by the knife blade part,
wherein the first coupling member is formed as at least one protrusion part and the second coupling member is formed as a screw groove, or the first coupling member is formed as a screw groove and the second coupling member is formed as at least one protrusion part,
wherein the pencil sharpening part comprises:
an upper rotation part, which has the second coupling part formed on the outer surface thereof so as to rotate as the pencil, which is inserted into the pencil sharpening part, carries out linear motion in the lengthwise direction of the housing part, and the knife blade part provided therein; and
a lower fixed part coupled to the lower side of the upper rotation part and moving vertically without rotational motion as the pencil, which is inserted into the pencil sharpening part, carries out linear motion in the lengthwise direction of the housing part.

22. The pencil sharpener as claimed in claim 21, wherein the at least one protrusion part comprises a protrusion formed to be protruded from a surface or comprises an inner groove and a ball inserted on the inner groove.

23. The pencil sharpener as claimed in claim 21, wherein the knife blade part is coupled to the inside of the upper rotation part and comprises at least one fixed blade.

24. The pencil sharpener as claimed in claim 21, wherein the knife blade part is coupled to the inside of the upper rotation part and comprises at least one spiral blade for rotating by the interaction between a central shaft, which is formed to be extended from the lower fixed part, and a blade shaft.

25. The pencil sharpener as claimed in claim 23, wherein the housing part further comprises a third coupling member formed in a linear shape on the inner surface thereof, and the lower fixed part comprises a fourth coupling member formed on the outer surface thereof and corresponding to the third coupling member.

26. The pencil sharpener as claimed in claim 23, wherein the pencil sharpener further comprises a spring part arranged at the lower side of the pencil sharpening part and providing upward restoring force in proportion to the lowering of the pencil sharpening part by the pencil, which is inserted into the pencil sharpening part.

27. The pencil sharpener as claimed in claim 23, wherein the pencil sharpener further comprises a lid part coupled to the upper side of the pencil sharpening part, arranged on the opening portion and having a pencil insertion hole, into which the pencil is inserted.

28. The pencil sharpener as claimed in claim 23, wherein the pencil sharpener further comprises a lid part coupled to the opening portion of the housing part,
wherein the lid part comprises:
a pencil insertion hole, into which the pencil is inserted; and
at least one roller part arranged around the pencil insertion hole and coming into contact with the surface of the pencil, which is inserted into the pencil insertion hole, so as to prevent the shaking of the pencil during the insertion motion of the pencil.

29. The pencil sharpener as claimed in claim 23, wherein the pencil sharpener further comprises a tension part arranged between the pencil sharpening part and the lid part and providing upward restoring force in proportion to the lowering of the pencil sharpening part by the pencil, which is inserted into the pencil sharpening part.

30. The pencil sharpener as claimed in claim 21, wherein the pencil sharpening part further comprises a ratchet part coupled between the upper rotation part and the knife blade part and rotating the knife blade part in a first direction when the upper rotation part rotates in the first direction, while preventing the knife blade part from rotating in a second direction when the upper rotation part rotates in the second direction,
wherein the knife blade part is coupled to the ratchet part and comprises at least one fixed blade, which is fixed and coupled on the inside thereof.

31. A pencil sharpener comprising:
a housing part having an upper end opening portion formed at one surface portion, a lower end opening portion formed at the opposite side of the upper end opening portion, and an accommodation space formed therein; and
a pencil sharpening part inserted into the accommodation space of the housing part and having a knife blade part provided therein,
wherein a first coupling member is formed on the inner surface of the lower end opening portion,
wherein the pencil sharpening part further comprises a rotation shaft part coupled at the lower side of the knife blade part and extended from the knife blade part to the lower end opening portion, and having a second coupling member formed on an outer surface thereof and corresponding to the first coupling member,
wherein the rotation shaft part is rotated by the first coupling member and the second coupling member as a pencil, which is inserted into the pencil sharpening part through the upper end opening portion, carries out linear motion in the lengthwise direction of the housing part, so that the pencil is sharpened by the knife blade part.

32. The pencil sharpener as claimed in claim 31, wherein the first coupling member is formed as at least one protrusion part, the second coupling member is formed as a screw groove, and the knife blade part comprises at least one fixed blade, which is fixed and coupled to the upper side of the rotation shaft part.

33. The pencil sharpener as claimed in claim 31, wherein the pencil sharpening part further comprises an upper fixed part coupled to the upper side of the rotation shaft part,
wherein the knife blade part is coupled to the inside of the upper fixed part and comprises at least one spiral blade for rotating by the interaction between a central shaft, which is formed to be extended from the rotation shaft part, and a blade shaft.
